(19) United States
(12) Patent Application Publication
(10) Pub. No.: US 2026/0267903 A1
(43) Pub. Date: Sep. 10, 2026

(54) SYSTEMS AND PROCESSES FOR RELATIONSHIP IDENTIFICATION

(71) Applicant: VITAL4DATA, LLC, Marietta, GA (US)

(72) Inventors: Kristin Stafford, Marietta, GA (US); Kellan Williams, Granville, OH (US)

(21) Appl. No.: 19/556,107

(22) Filed: Mar. 4, 2026

Related U.S. Application Data
(60) Provisional application No. 63/768,529, filed on Mar. 7, 2025.

(51) Int. Cl. G06F 16/35; G06F 16/34; G06F 40/30

(52) U.S. Cl. CPC G06F 16/35; G06F 16/34; G06F 40/30

(57) ABSTRACT

A relationship identification system for automatically processing and analyzing vast amounts of unstructured data to provide indications of relationships between a plurality of entities. The relationship identification system may determine entities by accessing a database of electronic information. One or more contextual links between the entities may be determined by scanning a plurality of media articles to extract references to each of the entities. A relationship between a first entity and one or more other entities may be determined by applying natural language processing (NLP) and text link analysis to the references. An indication of the relationship between the first entity and the one or more other entities may be transmitted in response to a query including the first entity.

### CROSS-REFERENCE TO RELATED APPLICATIONS

This application is a non-provisional application, claiming the benefit of and priority to U.S. Provisional Patent Application No. 63/768,529, entitled “SYSTEMS AND PROCESSES FOR RELATIONSHIP EXTRACTION,” filed on March 7, 2025, the entirety of which is incorporated by reference as if set forth entirely herein.

### TECHNICAL FIELD

The present disclosure relates generally to the field of data processing and analytics, and specifically to systems and methods for use of natural language processing (NLP) and machine learning to extract and analyze relationships between various entities, including individuals, organizations, and other identifiable groups.

### BACKGROUND

Many regulations require businesses to monitor and screen clients and employees. For example, the USA PATRIOT Act requires financial institutions to actively monitor and screen their clients for connections to fraud, terrorism, criminal activities, and other forms of financial malfeasance. Additionally, businesses and other organizations may wish to perform background checks on employees and clients. As another example, businesses and other organizations may wish to investigate individuals or other businesses for private or legal investigations. To meet these needs, businesses and other organizations rely on computing systems to extract and analyze relationships between entities. These systems rely on large volumes of unstructured text data sourced from news articles, legal filings, and any other publicly-available records and documents.

Existing computing systems for extracting and analyzing relationships from unstructured text data face significant technical challenges that limit their accuracy and utility. Traditional entity extraction systems rely on simple keyword matching or co-occurrence detection, which generates high false positive rates by treating incidental mentions (e.g., entities appearing in the same article by coincidence) as meaningful relationships. These systems lack the capability to distinguish between substantive connections and spurious associations, requiring extensive manual review to filter irrelevant results. Furthermore, conventional natural language processing systems fail to contextualize sentiment at the entity level, instead applying article-level sentiment broadly to all mentioned entities regardless of whether negative content actually pertains to a specific individual or organization. The computational complexity of processing millions of unstructured documents in real-time while maintaining relational context and sentiment granularity presents scalability problems that existing systems cannot adequately address. Additionally, prior relationship extraction systems do not dynamically update their analytical models based on accuracy feedback, resulting in static systems that cannot adapt to evolving language patterns, new entity types, or changing data structures. These technical limitations result in computing systems that produce unreliable relationship data with high false positives, requiring substantial human intervention to validate results. Therefore, there is a long-felt but unresolved need for a computing system that can accurately distinguish substantive entity relationships from incidental co-occurrences in unstructured text data while providing entity-specific contextual sentiment analysis at scale, dynamically reducing false positives through adaptive machine learning models that improve accuracy over time without requiring manual reconfiguration.

### SUMMARY

Briefly described, and in various aspects, the present disclosure generally relates to data processing and data analytics, particularly in the context of compliance and risk management. Moreover, the present disclosure may address challenges faced by financial institutions under regulatory mandates, such as the USA PATRIOT Act. This legislation compels institutions to actively monitor and screen their clients for connections to fraud, terrorism, criminal activities, and other forms of financial malfeasance. Additionally, businesses and organizations may wish to identify entities and relationships among entities for regulatory compliance, fraud investigations, background checks, company investigations, legal investigations, and public relationship purposes. To meet these needs, businesses rely on computing systems to generating profiles for entities. Traditional manual profiling methods, while essential for compliance, are arduous and prone to errors, often missing crucial data amidst vast quantities of electronic communications. Moreover, existing computing systems for identifying relationships among entities can generate false positives and lack the ability to contextualize sentiment. As an illustrative example, many profile generation and relationship identification systems rely on news articles to provide data related to entities. As an example, a news article may discuss a judge, an attorney, and a convicted felon. Existing systems may identify a negative affiliation between the judge, the attorney and the convicted felon without any additional context. For example, existing systems may inaccurately determine that the judge and/or the attorney is associated with the convicted felon based on co-occurrence in the news article. However, there exists a need for computing systems that accurately identify the relationship between the parties, the sentiment associated with the relationship, and the context regarding the relationship. As will be understood, the system disclosed herein can be used any time media identifies multiple entities. The systems and methods disclosed herein leverage natural language processing (NLP) and machine learning to parse through enormous datasets efficiently, identifying potential risks swiftly and accurately.

Aspects of the disclosure may utilize NLP and machine learning to extract and analyze complex relationships between various entities (e.g., individuals or organizations). Moreover, aspects of the disclosure may create and/or update profiles associated with the entities, e.g., including entity data such as name, nationality, birth dates, and other identifiers extracted from diverse media sources using NLP. The relationships among entities may be determined through text linking models that connect data points based on context, such as mentions alongside adverse activities or associations with known individuals of interest. This automated approach may significantly speed up the data processing and enhance the accuracy of the profiles, resulting in a system that can provide institutions with near-real time updates in response to new developments and reduces the likelihood of overlooking significant associations that existing systems might miss.

According to some aspects, the disclosed systems and methods may address challenges associated with immense and growing volumes of unstructured digital text data (e.g., ranging from online articles to social media posts) by automating the extraction of meaningful and actionable relationship insights. Moreover, the systems and methods may provide timely, accurate, and contextually relevant screening for relationships between various individuals, enhancing compliance measures and risk management processes, providing institutions with near-real time updates in response to new developments.

In various aspects, the disclosed system may comprise one or more computing devices equipped with processors that perform multiple functions to uncover and understand the nuances of entity relationships. The computing devices may access a comprehensive database containing detailed records of individuals, scanning through vast quantities of media articles to extract references to the individuals. By leveraging advanced NLP and text link analysis techniques, the system may discern complex contextual links between the entities, such as roles within organizations or interactions across various domains (e.g., financial transactions or public endorsements).

Moreover, based on the extracted data, the system may update one or more profiles (e.g., cloud-based) associated with the entities, mapping out the intricate web of relationships. According to some aspects, the system may determine relationships through graphs or network diagrams, enhancing the ability of users to monitor and analyze connections. Furthermore, the system may generate and transmit alerts in response to changes in the relationships, offering users the ability to react promptly to potential risks. These capabilities may provide significant advancement in compliance and risk management, where understanding the depth and breadth of the relationships can significantly impact decision-making processes.

Additionally, aspects of the disclosure may include a robust verification mechanism to further ensure the reliability of the data. Outputs from the relationship extraction processes may be cross verified using alternative data extraction methods, providing a layered approach to validation. This redundancy may aid in identifying and eliminating potential outliers, thereby refining the data quality. For example, discrepancies between entity identifications by different models may be analyzed to confirm the accuracy of the relationships established, ensuring that the profiles used in compliance and risk management are both current and meticulously vetted.

By automating the relationship extraction process, the disclosed systems and methods may streamline the identification and analysis of relationships, significantly reducing the likelihood of errors (e.g., false positives) in existing systems. For example, the capability of the system to provide real-time updates and maintain a continuously accurate database exemplifies a significant technological advancement over traditional methods. Moreover, use of machine learning may allow the system to improve its accuracy over time, learning from previous interactions to better identify and categorize entity relationships.

According to a first aspect, the present disclosure describes a system including: one or more processors; and a memory having instructions stored thereon that, when executed by the one or more processors, cause the system to: receive a query requesting relationship data corresponding to at least one first entity; retrieve a plurality of media content artifacts; identify at least one reference to the at least one first entity in the plurality of media content artifacts based on applying a natural language processing technique to the plurality of media content artifacts, wherein at least one of the plurality of media content artifacts identifies at least one second entity; identify a relationship between the at least one first entity and the at least one second entity based on the at least one reference; determine a sentiment associated with the relationship based on applying a machine learning model to the at least one reference; and generate a visual representation based on the relationship and the sentiment on a user interface displayed on the at least one computing device.

According to a second aspect, the system of the first aspect or any other aspect, wherein the instructions, when executed by the one or more processors, further cause the system to: identify a plurality of adverse indicators in a first media content artifact of the plurality of media content artifacts based on applying the natural language processing technique to the first media content artifact; identify a second sentiment associated with each of the plurality of adverse indicators; and generate a data object, wherein the data object aggregates each of the plurality of adverse indicators and the second sentiments.

According to a third aspect, the system of the second aspect or any other aspect, wherein the instructions, when executed by the one or more processors, further cause the system to: determine a classification of the first media content artifact based on applying a machine learning algorithm to the data object; and determine a confidence score associated with the classification based on the data object.

According to a fourth aspect, the system of the third aspect or any other aspect, wherein the classification includes at least one of a positive classification, a negative classification, and a neutral classification.

According to a fifth aspect, the system of the third aspect or any other aspect, wherein the instructions, when executed by the one or more processors, further cause the system to: determine a context associated with each of the plurality of adverse indicators and the at least one first entity.

According to a sixth aspect, the system of the fourth aspect or any other aspect, wherein the instructions, when executed by the one or more processors, further cause the system to: rank each of the plurality of media content artifacts based on an adverse classification.

According to a seventh aspect, the system of the sixth aspect or any other aspect, wherein the instructions, when executed by the one or more processors, further cause the system to: store each of the plurality of media content artifacts in the memory; and apply a metadata tag to each of the plurality of media content artifacts based on the classification.

According to an eight aspect, the system of the sixth aspect or any other aspect, wherein the instructions, when executed by the one or more processors, further cause the system to: filter the plurality of media content artifacts into one or more categories based on the classification.

According to a ninth aspect, the present disclosure describes a method, including: receiving, via one of one or more computing devices, a query requesting relationship data corresponding to at least one first entity; retrieving, via one of the one or more computing devices, a plurality of media content artifacts; identifying, via one of the one or more computing devices, at least one reference to the at least one first entity in the plurality of media content artifacts based on applying a natural language processing technique to the plurality of media content artifacts, wherein at least one of the plurality of media content artifacts identifies at least one second entity; identifying, via one of the one or more computing devices, a relationship between the at least one first entity and the at least one second entity based on the at least one reference; determining, via one of the one or more computing devices, a sentiment associated with the relationship based on applying a machine learning model to the at least one reference; and generating, via one of the one or more computing devices, a visual representation based on the relationship and the sentiment on a user interface displayed on the at least one computing device.

According to a tenth aspect, the method of the ninth aspect or any other aspect, further including: extracting, via one of the one or more computing devices, data associated with the at least one first entity from the plurality of media content artifacts; and updating, via one of the one or more computing devices, a profile associated with the at least one first entity to include the data.

According to an eleventh aspect, the method of the ninth aspect or any other aspect, further including: extracting, via one of the one or more computing devices, data associated with the at least one second entity from the plurality of media content artifacts; and generating, via one of the one or more computing devices, a profile associated with the at least one second entity, wherein the profile includes the data.

According to a twelfth aspect, the method of the ninth aspect or any other aspect, further including: predicting, via one of the one or more computing devices, an entity type associated with the at least one first entity based on the plurality of media content artifacts.

According to a thirteenth aspect, the method of the twelfth aspect, wherein the at least one first entity includes at least one of an individual or an organization.

According a fourteenth aspect, the method of the ninth aspect, wherein the natural language processing technique includes text link analysis.

According to a fifteenth aspect, the method of the ninth aspect, further including: determining, via one of the one or more computing devices, a relationship score based on the relationship and the sentiment.

According to a sixteenth aspect, the present disclosure describes a non-transitory computer-readable medium embodying a program that, when executed by at least one computing device, cause the at least one computing device to: receive a query requesting relationship data corresponding to at least one first entity; retrieve a plurality of media content artifacts; identify at least one reference to the at least one first entity in the plurality of media content artifacts based on applying a natural language processing technique to the plurality of media content artifacts, wherein at least one of the plurality of media content artifacts identifies at least one second entity; identify a relationship between the at least one first entity and the at least one second entity based on the at least one reference; determine a sentiment associated with the relationship based on applying a machine learning model to the at least one reference; and generate a visual representation based on the relationship and the sentiment on a user interface displayed on the at least one computing device.

According to a seventeenth aspect, the non-transitory computer-readable medium of the sixteenth aspect or any other aspect, wherein the program further causes the at least one computing device to: determine a change to the relationship between the at least one first entity and the at least one second entity based a second plurality of media content artifacts; and generate an alert on the user interface in response to determining the change.

According to an eighteenth aspect, the non-transitory computer-readable medium of the sixteenth aspect or any other aspect, wherein the program further causes the at least one computing device to: identify the at least one second entity based on applying the natural language processing technique to the plurality of media content artifacts; and validate the at least one second entity based on applying a second natural language processing technique to the plurality of media content artifacts.

According to a nineteenth aspect, the non-transitory computer-readable medium of the eighteenth aspect or any other aspect, wherein the natural language processing technique includes named entity recognition.

According to a twentieth aspect, the non-transitory computer-readable medium of the eighteenth aspect or any other aspect, wherein the natural language processing technique includes tokenization.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an environment for a relationship identification system;

FIG. 2 illustrates an example of a process for determining relationships;

FIG. 3 illustrates a schematic of an example of a relationship extraction screening device; and

FIG. 4 illustrates an example diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

The terms “about” and “approximately” shall generally mean an acceptable degree of error or variation for the quantity measured given the nature or precision of the measurements. Numerical quantities, including height, width, and length, given in this description are approximate unless stated otherwise, meaning that the term “about” or “approximately” can be inferred when not expressly stated. Any numerical value described in conjunction with “about” or “approximately” includes all values within a ±5% range of variation of the corresponding numerical value, unless expressly stated otherwise. For example, a stated value of “approximately 100 units” would include 100 units, as well as 95 units (i.e., -5% variation), 105 units (i.e., +5% variation), and all unit values therebetween.

Throughout the specification and the claims, the following terms take at least the meanings explicitly associated herein, unless the context clearly dictates otherwise. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

The term “or” is intended to mean an inclusive “or.” Further, the terms “a,” “an,” and “the” are intended to mean one or more, unless specified otherwise or clear from corresponding context to be directed to a singular form.

Unless otherwise specified, the use of ordinal adjectives (“first,” “second,” “third,” etc.) to describe a common object merely indicate that different instances of like objects are being referred to and are not intended to imply that the objects so described should be in a given sequence, either temporally, spatially, in ranking, or in any other manner.

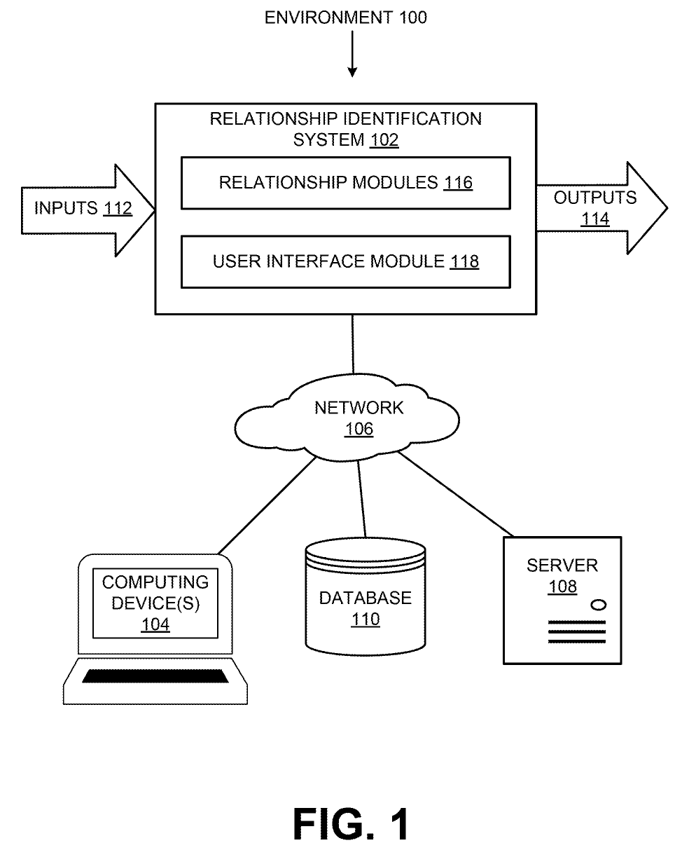

Referring now to the figures, for the purposes of example and explanation of the processes and components of the disclosed systems and methods, reference is made to FIG. 1, which illustrates an environment 100 for the relationship identification system 102. The environment 100 may include one or more interconnected components that facilitate the identification and analysis of relationships between individuals and entities across various domains. As referred to herein, an “entity” or “entities” generally refers to individuals, companies, organizations, or any other entity for which information about a relationship or affiliation with another entity is desired. Non-limiting examples of entities, as referred to herein, include people, persons of interest, celebrities, politicians, business leaders, companies, business organizations, non-profit entities, for-profit entities, corporations, limited liability companies, partnerships, other business organizations, governmental agencies, universities, research organizations, or any other similar type of entity or organization. Computing devices 104 (e.g., utilized by analysts and compliance officers) may be connected via a network 106 to the relationship identification system 102. The relationship identification system 102 may process and analyze relationship data. A server 108 may ingest and process large volumes of structured and unstructured data using NLP and machine learning models, assigning relevance scores and refining analytical methodologies over time. A database 110 may serve as a repository for storing entity relationships, relevance scores, historical queries, and/or configuration settings, supporting dynamic entity resolution and analysis. Inputs 112 may include diverse real-time and historical data sources, such as news articles, corporate filings, legal documents, social media, and/or compliance databases. In some embodiments, the inputs 112 can be retrieved from the internet and other media sources. Outputs 114 may include reports, alerts, and graphical representations that provide actionable insights into relationship dynamics. The relationship modules 116 may perform specialized functions such as entity database management, NLP-based text extraction, text link analysis for relational mapping, and/or real-time alerting. The user interface (UI) module 118 may enable users to interact with the relationship identification system 102 through intuitive search filters, data visualization tools, and/or alert mechanisms, streamlining the identification and assessment of complex relationships for investigative, compliance, and risk management purposes.

According to some aspects, the relationship identification system 102 may address the substantial challenges faced by financial institutions under regulations such as the USA PATRIOT Act, which mandates the monitoring of individuals and organizations for any involvement in fraud, terrorism, or other criminal activities. Traditionally, this monitoring has been accomplished through labor-intensive manual processes where financial institutions must sift through extensive amounts of media content to create and maintain profiles indicative of such activities. For example, profiling often requires manual analysis of relationships and connections between various entities, which may be manually updated to reflect any new findings. Moreover, existing computing systems for relationship extraction can generate false positives and lack the ability to contextualize sentiment. By automating and improving on existing computing systems, the relationship identification system 102 may significantly enhance the accuracy and efficiency of these activities, ensuring compliance with regulatory requirements, improving responsiveness, and reducing human error.

According to some aspects, the relationship identification system 102 may classify certain articles as “adverse articles” based on their content, e.g., concerning one or more identified entities. As will be understood by those skilled in the art, classifying media as “adverse” can indicate that the media expresses a negative viewpoint regarding one or more entities and/or indicates risky or potentially problematic actions or behavior by one or more entities. For example, the relationship identification system 102 can classify any media as adverse, including but not limited articles (e.g., text), images, and videos. As will be understood, any “article,” “media,” “media content artifacts” discussed herein can include any type of media or communication and can include any text, images, videos, and any other document and/or file. This classification may be achieved through use of sentiment analysis machine learning models that assess the tone and context of mentions within the articles. For example, articles that include mentions of entities in contexts related to criminal activities, financial misconduct, fraud, compliance and regulatory violations, risky financial activity, labor violations, ethical violations, negligence, or other negative connotations may be deemed as adverse. Moreover, the machine learning models may analyze textual data to determine the sentiment expressed, categorizing articles as adverse when they contain negative implications that could impact compliance assessments and risk management processes.

According to some aspects, the relationship identification system 102 may use NLP machine learning models to parse and analyze vast amounts of structured and unstructured data. The relationship identification system 102 may process diverse data sources, including news articles, social media content, and electronic communications, to extract relevant information about individuals and organizations. In some aspects, the processed data may include adverse articles, or, in some other aspects, the processed data may consist of only articles that have been determined to be adverse. For example, the relationship identification system 102 may identify and extract references to known terrorists or individuals involved in money laundering from online adverse articles, flagging these entities for further scrutiny and/or profiling. For example, the machine learning models can be trained to determine relationships among entities in the structured and unstructured data. As an example, the machine learning models can be trained using a labeled data set (e.g., supervised training).

According to some aspects, the relationship identification system 102 may use advanced NLP and/or machine learning algorithms to extract complex relationships between entities such as individuals, organizations, and/or governmental bodies. Based on syntactic and semantic analysis, the relationship identification system 102 may discern nuanced interactions that might be missed by less sophisticated systems. This technical approach may allow for the identification of relationships based on context, rather than mere co-occurrence, which may significantly enhance the accuracy of the extracted data. As another example, the NLP and machine learning models may identify relationships among entities based on predefined linguistic rules (e.g., keywords, sentence structure, word usage).

To further refine the extraction process, the relationship identification system 102 may utilize adaptive learning models that evolve based on continuous data input. Based on the adaptive learning models, the relationship identification system 102 may learn from past mistakes and adapt to new patterns or changes in data structure, ensuring the extraction process remains relevant as data evolves. For example, if new terminologies or entities emerge in data feeds, the relationship identification system 102 may adjust its parameters to include the adjusted parameters in future analyses without manual reconfiguration. Moreover, the relationship identification system 102 may integrate one or more data validation layers to ensure the reliability of the extracted relationships. The data validation layers may cross-verify the extracted data with existing databases and previously verified information to reduce the likelihood of false positives. For example, the relationship identification system 102 may compare any identified relationships against any existing entity profiles.

The relationship identification system 102 may analyze a diverse array of media sources to ensure comprehensive and accurate screening for identification of relationships between various individuals and organizations. For example, the relationship identification system 102 may process information from traditional news outlets (e.g., major newspapers such as The New York Times®, The Guardian®, or The Washington Post®) which may provide coverage of international and domestic events that might influence compliance and risk assessments. The relationship identification system 102 may analyze publications from digital media platforms, such as online news portals (e.g., Reuters® or CNBC®), which may offer real-time updates and in-depth analysis on a wide range of topics pertinent to regulatory compliance. As another example, the relationship identification system 102 may analyze media from one or more RSS feeds subscribed to one or more websites and publications. Specialized publications, including industry-specific magazines such as Forbes® and Bloomberg Businessweek®, may provide insights into economic trends and corporate affairs that could signal potential risks or relationships worth investigating. The relationship identification system 102 may further extend its reach to academic journals available through repositories like JSTOR, where scholarly articles may provide detailed studies and reports that can shed light on less obvious relationships or historical data relevant to an individual or entity. Moreover, the relationship identification system 102 may harness the power of social media platforms, including Twitter®, X®, Facebook®, Instagram®, LinkedIn®, and others, where individuals and organizations may frequently share updates that might reflect on their professional networks and relationships. Blogs and opinion pieces, often found on independent websites or media platforms like Medium®, may be scrutinized for nuanced perspectives or detailed commentary that may indicate underlying connections not evident in mainstream media. As will be understood, the relationship identification system 102 can retrieve media from any source, and the foregoing examples should not be construed as limiting. The retrieved media can be provided to the relationship identification system 102 as the inputs 112. The retrieved media and any data extracted from the media can be stored in the database 110.

By integrating data from varied sources, the relationship identification system 102 may provide an analysis that includes current information and encompasses a broad spectrum of perspectives and content types. This holistic approach may provide a more nuanced understanding of the relationships and potential compliance risks associated with individuals, enhancing the effectiveness of the screening processes.

The relationship identification system 102 may address technical challenges associated with managing and interpreting vast amounts of unstructured data. For example, sophisticated data processing technologies may streamline the extraction and analysis of relevant information from the diverse array of digital media sources. By employing advanced NLP algorithms, the relationship identification system 102 may parse through extensive textual data, identifying key terms and phrases that indicate an individual’s relationships with one or more other individuals. For example, the relationship identification system 102 may use text link analysis to construct relational graphs that visually and conceptually map the connections between individuals. For example, text link analysis can include NLP techniques to parse media and identify any co-occurrence of one or more entities. Text link analysis can extract data indicating relationships (e.g., relationship indicators) and generate relational graphs (e.g., visual representations of relationships among one or more entities). For example, text link analysis can include applying NLP semantic analysis to distinguish between substantive relationships and mere co-occurrence based on contextual indicators included in the media. According to some aspects, the NLPs may address the technical problem of relational ambiguity in unstructured data, where traditional keyword searches might fail. By analyzing the context in which names and references to individuals appear, the relationship identification system 102 may discern substantive connections from incidental mentions, thereby reducing false positives (a common issue in compliance checks). As another example, the NLP techniques may include tokenization.

Moreover, the relationship identification system 102 may update database(s) (e.g., database 110) in real-time as new data becomes available (e.g., the relationship identification system 102 receives newly-published or newly-available media as the inputs 112) using a machine learning feedback loop. The updates may address inaccuracies or missing data resulting from data obsolescence in rapidly changing regulatory environments. For instance, if a corporate executive is appointed as the Chief Technology Officer following a high-profile merger, the relationship extraction system 102 may update its database with this new information from public disclosures, allowing compliance officers to immediately see updated network diagrams and reports reflecting the executive’s new affiliations for timely compliance assessment. Additionally, the relationship identification system 102 may utilize machine learning models to continuously learn from new data inputs and user feedback to improve the accuracy and relevance of the screening outcomes, demonstrating an adaptive response to the evolving nature of data patterns and regulatory requirements. For example, if an individual has previously collaborated with technology entrepreneurs, machine learning algorithms could predict that this person is likely to form future partnerships with other similar professionals in the tech sector. This predictive capability may facilitate proactive compliance and risk management, allowing organizations to anticipate and address potential issues before they arise.

For example, the machine learning models can include large language models (LLMs) or any other machine learning model. Such models can be used individually or in combination to perform the various steps, processes, and/or functionalities described herein (e.g., data analysis, intent determination, reasoning, action execution). The LLM(s) can be trained or otherwise developed according to various different training methods and/or for various different intended applications. For example, the model(s) can be or include instruction-tuned models (e.g., trained to follow natural language commands and produce task-oriented outputs), as non-limiting examples. Alternatively or in addition, the model(s) can be or include domain-specific models, which can be include models that were pre-trained and/or fine-tuned according to specialized corpora (e.g., specific technical or financial data) to improve accuracy and reliability within a particular subject matter, as non-limiting examples. Alternatively or in addition, the model(s) can be or include retrieval-augmented generation (RAG) models, which can integrate external knowledge sources at an inference time, as non-limiting examples. These models can combine a retriever component with a generative model to ground responses in up-to-date (e.g., current) and/or proprietary data, as non-limiting examples. Alternatively or in addition, the model(s) can be or include small or compact language models, which can be optimized for low latency, reduced computational cost, and/or on-device or edge deployment, as non-limiting examples.

The model(s) can range from large, general-purpose models capable of deep semantic understanding and zero-shot or few-shot reasoning, to smaller or fine-tuned models optimized for efficient classification and local deployment (e.g., in the context of data pre-analysis, data cleaning, feature extraction, and/or intent determination). Alternatively or in addition, the model(s) can include one or more specialized embedding and/or sequence-based models (e.g., to map inputs into vector representations for similarity matching, clustering, and/or intent classification). Alternatively or in addition, the model(s) can include one or more table- or structure-aware models (e.g., to analyze structured or semi-structured data such as spreadsheets or databases).

The model(s) can leverage one or more techniques, such as chain-of-thought or multi-step reasoning (e.g., enabling intermediate analytical steps) and/or retrieval augmentation (e.g., retrieving relevant contextual data prior to intent determination). Illustrative use cases can include automated data cleaning, user intent recognition, and/or large-scale data annotation. Alternatively or in addition, the model(s) can include one or more LLMs for action determination, planning, and/or execution (e.g., agent-based workflows, autonomous workflows). These can include general-purpose reasoning models (e.g., for interpreting intent and mapping it to executable actions) and/or large reasoning models (e.g., for complex and/or multi-step logical decision-making). Alternatively or in addition, the model(s) can include one or more mixture-of-experts models or fine-tuned task-specific models (e.g., to generate structured outputs, such as executable code, tool invocations, or API calls).

As another example, the machine learning models can include any machine learning algorithm or model or combination thereof, including but not limited to nearest neighbor, support vector machines, gradient boosting, neural networks, logistic regression, linear regression, decision trees, random forest, Naive Bayes, k-means clustering, time series regression, pointwise prediction, stepwise regression, Gaussian models, hidden Markov models, ensemble learning models, means-shift clustering, and Bayesian models.

According to some aspects, incorporation of a machine learning feedback loop within the relationship identification system 102 may further refine the reliability of the data extraction process. This feedback mechanism may identify and discard profiles that do not meet accuracy criteria, such as those mistakenly created for non-relevant entities or based on incorrect data. For example, the relationship identification system 102 may automatically differentiate between real entities and fictional characters such as Princess Leia (from the well-known Star Wars® movies), whose profile would be irrelevant for compliance purposes. This automated discernment may significantly reduce the workload on compliance officers and enhance the overall integrity of the monitoring process. For example, fictional characters can be identified based on a database of fictional characters.

According to some aspects, the relationship identification system 102 may include one or more additional verification steps to ensure the accuracy of the extracted data. These verification steps may include cross verifying the automated extraction results with those obtained from secondary analysis methods or different computational models. For example, entities identified by a primary NLP model (e.g., Modeler) may be cross-checked using a secondary NLP model (e.g., Rosette) to confirm the accuracy of entity extractions. Discrepancies between the models may be identified to allow the relationship identification system 102 to correct errors proactively, ensuring that only verified and accurate data is used in the profiling and monitoring processes. As an illustrative example, models can predict different entity types, and the different entity type predicts can be identified as a discrepancy.

The relationship identification system 102 may integrate with external compliance management systems, facilitating a unified approach to risk assessment and regulatory reporting. External compliance management systems may include software solutions or platforms used by organizations to ensure they adhere to regulatory requirements, industry standards, and internal policies. The external compliance management systems may include Anti-Money Laundering (AML) systems, Know Your Customer (KYC) systems, regulatory compliance management systems, fraud detection systems, or Enterprise Risk Management (ERM) systems. This integration with external compliance management systems may allow for seamless data flow and consolidated risk management processes, ensuring that all compliance-related data points are coherently tracked and assessed across platforms. For example, if a compliance query identifies a high-risk relationship, the relationship identification system 102 may automatically initiate a detailed risk assessment protocol, pulling in additional data from connected systems to provide a comprehensive risk profile. For example, any data from an external compliance system can be provided to the relationship identification system 102 as the inputs 112.

According to some aspects, integration of the relationship identification system 102 with existing compliance management infrastructures may enable real-time updates and seamless data synchronization. Moreover, the integration may allow financial institutions to respond swiftly to new legislative changes or updates in compliance requirements, incorporating new monitoring parameters automatically into the relationship identification system 102. For example, if legislation introduces a new category of monitored activities, the relationship identification system 102 may adapt its parameters accordingly without manual input, maintaining compliance continuity. As an example, the relationship identification system 102 can receive updates to compliance regulations and laws via the external compliance system. These dynamic capabilities may ensure that financial institutions remain compliant with evolving regulations, minimizing the risk of non-compliance and associated penalties.

According to some aspects, the relationship identification system 102 may access a dynamically updated database of known people of interest. Utilizing a combination of NLP and text link analysis, the relationship identification system 102 may scan through a multitude of media articles to extract references to these entities. The relationship identification system 102 may identify associated entities and their relationships to other associated entities. Moreover, the relationship identification system 102 may update a profile database (e.g., database 110) to include any identified relationships. For example, one or more relationships between individuals associated with the same entity may be tagged in the profile database. The database may trigger alerts whenever there is a change in the status of one or more relationships, ensuring that the relationship identification system 102 is informed of the most current information.

Moreover, the relationship identification system 102 may respond to specific queries by providing indications of the entities involved. For example, the indications can be provided as the output 114. The indications may include information about the relationships associated with entities relative to one or more other entities. Integration of the relationship identification system 102 with external compliance systems may facilitate a cohesive and collaborative approach to managing regulatory requirements across various platforms. The relationship identification system 102 may also assess regulatory risks (e.g., determining a regulatory risk factor based on the relationships and/or sentiment associated with the individuals and other individuals to which they are related) that could influence the context of the relationships.

The relationship identification system 102 may include one or more relationship modules 116, each dedicated to specific functions within the relationship extraction process. The relationship modules 116 may work together to manage the entity relationship database, perform NLP-based text analysis, conduct text link analysis, and/or manage alert systems.

According to some aspects, the relationship modules 116 may use advanced machine learning models to identify and categorize entities within the input data. The machine learning models may discern or predict various entities and/or entity types by recognizing patterns and contextual clues within the data. For example, the machine learning models may differentiate between personal names and organizational names based on context cues in the surrounding text. As another example, the machine learning models may classify entities based on a formed entity type (e.g., corporation, partnership, LLC, sole proprietorship, non-profit organization, cooperative, governmental entity, professional or social associations). Moreover, the machine learning models may analyze the connections between the entities to establish relationship mappings. By employing sophisticated text link analysis techniques, the relationship modules 116 may interpret the nature of relationships expressed within the data.

Aspects of the relationship identification system 102 may comprise a machine learning model trained to analyze patterns and relationships within vast datasets, allowing the relationship identification system 102 to accurately and reliably identify entities, determine relationships between the entities, and/or indicate the strength of relationships between entities. The machine learning model may adaptively refine its predictions based on new data, enhancing the ability of the machine learning model to provide timely and accurate insights for compliance and risk management purposes.

The training of the machine learning model may begin with data collection and preprocessing, where data from diverse sources such as news articles, social media posts, financial reports, and public records is cleaned and prepared by removing noise and irrelevant information. The processed data may be stored in the database 110. Feature extraction techniques such as Named Entity Recognition (NER) may be utilized to identify and classify entities, assign context scores to determine relevance, and/or calculate relevance scores to quantify the strength of relationships. As will be understood, the context scores and relevance scores can include the relationship scores. The machine learning model may then be trained using various methods, such as supervised learning. For example, the machine learning model may be trained with labeled datasets from the database 110 and may use algorithms such as Support Vector Machines (SVM), random forest, and Neural Networks to confirm associations between entities and individuals.

Unsupervised learning may be used along with clustering techniques such as K-Means and hierarchical clustering to group similar entities and identify potential relationships. Semi-supervised learning may be used to train the machine learning model and may combine labeled and unlabeled data from the database 110 to improve model accuracy. Reinforcement learning may include implementing feedback loops where the machine learning model receives feedback from compliance officers and adjusts its predictions based on this feedback to train the machine learning model.

The relationship modules 116 may map relationships including nuanced scenarios where the interactions between entities are subtle. This level of analysis may provide detailed insights into the dynamics between entities, which can be pivotal for applications such as market analysis, risk assessment, and strategic planning. Moreover, the relationship modules 116 may continuously refine their understanding and categorization of relationships through ongoing machine learning. As they encounter new data and examples, the algorithms may adjust and improve, enhancing their predictive accuracy over time. This dynamic learning process may allow the relationship modules 116 to stay updated with evolving language use and relationship dynamics, ensuring that the extracted relationship data remains relevant and actionable.

According to some aspects, the relationship modules 116 may include an entity recognition module for identifying and classifying different types of entities within the input data, such as individuals, organizations, locations, and dates. The entity recognition module may access and manage a dynamic database (e.g., database 110) of known entities. The module may regularly update and maintain the database of known entities with information from a variety of public and proprietary sources, keeping the data current and comprehensive. Utilizing NLP techniques, the entity recognition module may parse unstructured text to locate and label entities and their relationships to other entities. For example, in a news article, the entity relationship module may identify names of one or more people, companies, or cities. Thereby the entity recognition module may form a foundation of the relationship extraction process by determining the elements between which relationships might exist.

According to some aspects, the relationship modules 116 may include a context analysis module. The context analysis module may examine the text surrounding the entities to understand the context in which they are mentioned. The context analysis module may distinguish between different uses of the same term, such as whether “Apple” refers to the corporation or the fruit, based on the surrounding text such as “technology” or “orchard.” Moreover, the context analysis module may leverage contextual clues to accurately map out relationships, which may be beneficial for analyzing and understanding complex interaction networks in varied textual data.

According to some aspects, the context analysis module may discern relationships between individuals by examining the textual context in which their names are mentioned. For example, consider a sentence from a news article: “Dr. Sarah Thompson and Professor John Miller co-authored a groundbreaking study on climate change.” Here, the entity recognition module may identify “Dr. Sarah Thompson” and “Professor John Miller” as entities, e.g., recognizing them as individuals through their professional titles. The context analysis module may scrutinize the surrounding text for keywords that might indicate a relationship, with “co-authored” suggesting a collaborative link. This keyword, coupled with the context provided by the description of their joint work on a significant project, may allow the context analysis module to establish that their relationship is of a professional and academic nature, specifically focused on research collaboration.

According to some aspects, the relationship modules 116 may include a relationship mapping module. The relationship mapping module may map the relationships between identified entities based on the identified entities and determined relationships. For example, if entities such as individuals, companies, or organizations are identified along with their interactions, such as partnerships, transactions, or affiliations, the relationship mapping module may create diagrams or graphs illustrating or storing how the entities are interconnected. This mapping may include creating nodes for each entity and connecting the nodes based on one or more different types of relationships (e.g., with varying properties to indicate the strength or nature of the relationship). Moreover, one or more graphical representations of the mapping may be provided to allow users to quickly comprehend complex networks and assess the dynamics within them, such as identifying influential entities, potential conflict zones, or key collaborative clusters. Thereby the relationship mapping module may transform raw data into a structured, easily interpretable format, enhancing decision-making processes in compliance, risk management, or strategic planning.

According to some aspects, the relationship modules 116 may include a sentiment analysis module. The sentiment analysis module may evaluate emotional tone of the text surrounding entity interactions to better understand the nature of the relationship and classify the relationship (e.g., based on whether the sentiment is positive, negative, or neutral). For example, if two entities are mentioned together with positive terms like “successful partnership,” it suggests a favorable relationship, which is different from a context filled with terms like “contentious litigation,” which could indicate a negative relationship. In the first example, the sentiment analysis module could classify the relationship as positive, and in the second example, the sentiment analysis module could classify the relationship as negative.

According to some aspects, the relationship modules 116 may include a data enhancement module. The data enhancement module may refine and enhance the relationship data by incorporating external datasets and feedback. For example, the data enhancement module may integrate information from databases (e.g., corporate registries or legal databases) to add more detail to the identified entities and their relationships. Additionally, the data enhancement module may learn from corrections and inputs provided by users to improve the accuracy and richness of the relationship data. For example, if the relationship status between two entities requires frequent correction, the data enhancement module may adapt to recognize new patterns or errors in initial assessments.

Embodiments of the relationship identification system 102 may comprise a user interface (UI) module 118 serving as a centralized interactive platform that may enable users to actively engage with the relationship extraction process. The UI module 118 may be designed with user experience in mind, facilitating the exploration, manipulation, and analysis of relationship data. The UI module 118 may allow users to input queries, view relational graphs, or access detailed profiles and histories of entities. As will be understood, the UI module 118 can generate a user interface for display on the computing device(s) 104 and receive any user input via the computing device(s) 104.

The UI module 118 may streamline complex data interactions by presenting information in an organized manner, allowing users to easily navigate through various layers of data. For example, a compliance officer may use the UI to quickly set parameters for a search, review the relationships of a particular individual with one or more entities, and/or access historical data that indicates patterns of association or potential conflicts of interest. Moreover, the UI module 118 may display alerts and updates in real-time, ensuring that users receive immediate notifications about significant changes or updates in the status of the entities or individuals being monitored.

By incorporating search filters and data visualization tools, the UI module 118 may allow users to perform targeted searches and interpret the results effectively. The data visualization tools may include dynamic relational graphs that visually map the relationships between entities and/or heat maps that highlight areas of high risk or concern based on the distribution of entities and relationships. Moreover, the UI module 118 may integrate seamlessly with external compliance and risk management systems, enabling a unified approach to data handling and decision-making. This integration may allow data to flow smoothly between systems, facilitating a comprehensive compliance strategy that leverages up-to-date and accurate information.

Customization options within the UI Module 118 may allow users to tailor the interface to their specific needs, enhancing their productivity and the relevance of the information displayed. Users may configure dashboards to show the most pertinent data and set up alerts to notify them of significant changes or updates. Moreover, the UI Module 118 may incorporate security features that protect sensitive data and ensure that access is controlled. User authentication, role-based access control, and/or data encryption may safeguard the information within the relationship identification system 102 from unauthorized access. Accordingly, the UI module 118 may simplify user interactions with complex datasets and enhance the efficiency and effectiveness of the screening processes. By providing a user-friendly interface that addresses the specific needs of compliance and risk management professionals, the UI module 118 may support proactive management of regulatory obligations and risk in a global and often volatile operational landscape.

Connected to the relationship identification system 102 may be one or more computing devices 104, each of which may vary widely in their design and application but sharing a common capability to process and analyze data. The computing devices 104 may be employed by compliance officers, risk managers, and/or other personnel engaged in due diligence and background checks to conduct screenings for relationships with or between various entities across multiple media sources. The one or more computing devices 104 may be interconnected via a network 106, enabling the sharing and transmission of data and analytical results throughout the environment 100.The computing devices 104 can include any device capable of accessing the network 106 including but not limited to, a computer, smartphone, tablet, mobile computing device, or other device. Network 106 may encompass a variety of networking technologies to facilitate the seamless flow of information and ensure the robust operation of the relationship identification system 102. For example, the network 106 can include, for example, the Internet, intranets, extranets, wide area networks (WANs), local area networks (LANs), wired networks, wireless networks, or other suitable networks, etc., or any combination of two or more such networks

A server 108 within the environment 100 may operate as a central processing unit and repository for applications and services related to the systems and methods for the application of one or more of NLP and/or machine learning models for relationship extraction. In this capacity, the server 108 may manage the ingestion, processing, and analysis of large volumes of unstructured text data, apply advanced algorithms to determine the presence of entities, and assess the context surrounding these entities to identify potential relationships. The server 108 may synthesize the information into coherent relationship profiles that may be stored in the database 110.

Upon successful identification and analysis, the server 108 may categorize the data and assign relationship scores, which may be stored and may be queried by users through the UI module 118. The relationship scores may enable users to ascertain a level of risk or importance of the relationships associated with the identified entities. For example, the relationship score can represent a strength of a relationship (e.g., based on co-occurrence in media), contextual proximity in media, and sentiment. Moreover, the server 108 may facilitate continuous improvement of screening accuracy by updating the underlying NLP and/or machine learning models based on feedback and new data, implementing adjustments and refinements to the relationship extraction processes, facilitating evolution of the relationship identification system 102 in alignment with emerging trends and patterns in data.

Additionally, the server 108 may distribute updates, such as enhanced algorithms, improved linguistic rulesets, and/or expanded entity databases, to computing devices 104 and other components of the relationship identification system 102. By centrally managing these updates, the server 108 may facilitate cohesive functioning of the relationship identification system 102, maintaining the highest levels of performance and accuracy in relationship extraction.

A database 110 may serve as a repository for storing and managing data for the relationship identification system 102. The database 110 may adopt various forms to address the complex data management needs inherent to the identification and evaluation of entity relationships. The database 110 may include a relational database organizing structured data with predefined relationships, facilitating retrieval of entities, context analyses, and related information. Moreover, to manage the vast and heterogeneous unstructured data inherent to relationship extraction, the database 110 may include a NoSQL model. The NoSQL model may provide flexibility to accommodate various data types and structures, allowing for scalable data storage that may handle high-velocity and high-volume data influx. According to some aspects, the database 110 may be cloud-based, allowing for data redundancy and ensuring that data is securely stored and accessible from multiple geographic locations, facilitating seamless access for distributed users and systems, supporting continuous relationship extraction operations.

The database 110 may retain processed information, including identified entities, associated relationships with other entities, relationship scores, and/or the context within which the entities are mentioned in media sources. Moreover, the database 110 may store the results of relationship scoring, which may indicate the strength of relationships between entities and identified relationships. Additionally, the database 110 may archive historical search results and user queries, creating a knowledge base that may be used for trend analysis, pattern recognition, and/or refinement of the system’s analytical models. Moreover, the database 110 may contain configuration settings and parameters for the relationship extraction components of the environment 100, allowing for dynamic adjustment to operational aspects of the relationship extraction process. By maintaining this dataset, the database 110 may allow the relationship identification system 102 to evolve by learning from new data and user feedback, thereby progressively enhancing the accuracy and reliability of the relationship extraction.

Inputs 112 into the relationship identification system 102 may be derived from a broad spectrum of data sources essential for conducting relationship extractions. For example, the inputs 112 may include real-time data streams capturing up-to-the-minute news articles, social media posts, financial reports, online articles, public filings, court transcripts, legal documents, etc., alongside structured and unstructured databases that aggregate historical media content, corporate records, and various compliance lists. Additionally, the inputs 112 may include user-generated queries, such as specific names, keywords, or phrases related to entities of interest. This multifaceted data collection may allow the relationship identification system 102 to perform a comprehensive scan of available information, ensuring that the relationship extraction is both current and historically aware.

Outputs 114 from the relationship identification system 102 may include results from the relationship extraction process, e.g., providing users with precise and actionable information. The outputs 114 may be tailored to the specific needs of compliance and risk management workflows. For example, detailed reports and analytical summaries may provide users with deep insights into the context and relationships associated with each of the identified entities. Moreover, reports may guide strategic decision-making and risk assessments by highlighting potential relationships, enabling organizations to proactively manage and mitigate reputational and compliance risks.

Additionally, the outputs 114 may include alerts and notifications to inform users of critical findings. The alerts may vary in format (e.g., from emails and push notifications to interactive dashboards within the system’s user interface) and may convey the urgency and relevance of the findings. The outputs 114 may allow compliance officers and risk managers to quickly assess and respond to potential risks. The outputs 114 may also include visualization tools that map entities and their connections to identified relationships, offering a clear and intuitive understanding of the data relationships. Such visual outputs may simplify complex data sets, making them easily interpretable and actionable. To enhance operational efficiency, the alerts and visualizations may be prioritized based on predefined criteria such as the severity of the risk or the relationship score, allowing the most significant issues to be addressed promptly and effectively.

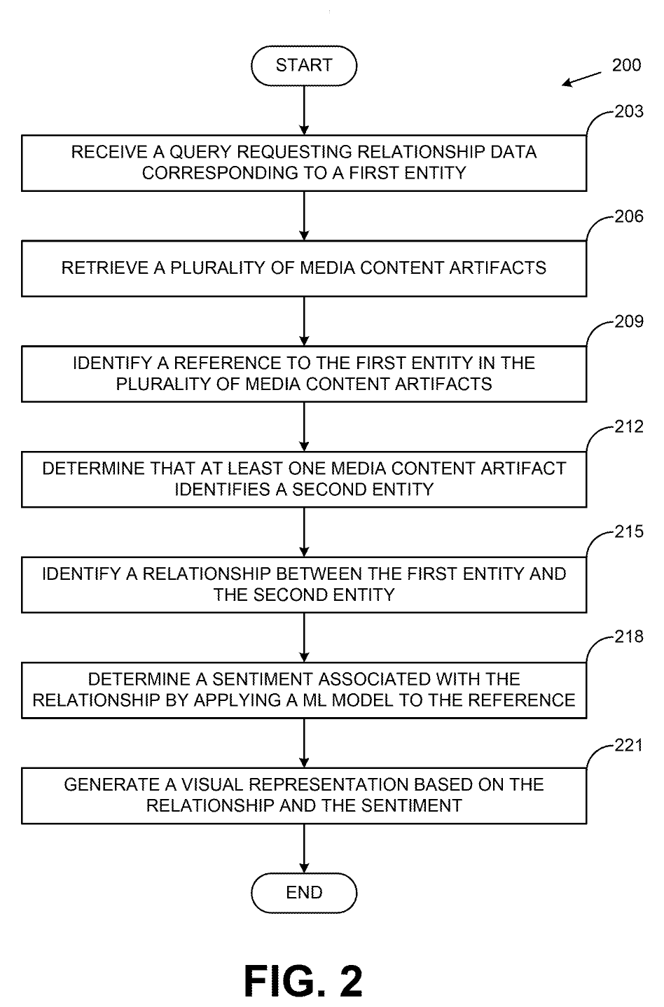

Referring now to FIG. 2, illustrated is a flowchart of a relationship identification process 200, according to an aspect of the disclosed systems and processes. The process 200 may demonstrate a method for extracting relationships between entities (e.g., persons of interest). Moreover, the process 200 may leverage data analytics technologies to streamline and enhance the screening process. The process 200 may be used to navigate complexities imposed by regulations such as the USA PATRIOT Act, which demands rigorous monitoring and profiling to prevent activities related to fraud, terrorism, and other criminal behaviors. The process 200 may extract and analyze complex relationships between various entities, employing a series of data-driven steps that leverage advanced NLP and machine learning techniques. The process 200 may refine relationship data through identification, extraction, analysis, and reporting steps, facilitating enhanced understanding and actionable insights into the interactions and networks among individuals and organizations, such as suspicious activities or connections to known or suspected persons of interest. Each step of the process 200 may address specific technical challenges associated with the ambiguity and vastness of digital data sources, ensuring accurate and timely delivery of relationship assessments for regulatory compliance and/or risk management applications.

As will be understood by one having ordinary skill in the art, the steps and processes shown in FIG. 2 may operate concurrently and continuously, are generally asynchronous and independent, can be performed in any order and in part or in whole by a combination of one or more of the relationship identification system 102, the computing devices 104, the database 110, and the server 108 and are not necessarily performed in the order shown and various steps can be executed linearly or in parallel.

According to some aspects, the process 200 may include a machine learning feedback loop to further refine the reliability of the data extraction process. For example, the feedback loop may identify and discard profiles that do not meet accuracy criteria, such as those mistakenly created for non-relevant entities or based on incorrect data. Moreover, the process 200 may automatically differentiate between real entities and fictional characters such as Princess Leia, whose profile would be irrelevant for compliance purposes. This automated discernment may significantly reduce the workload on compliance officers and enhance the overall integrity of the monitoring process.

At step 203, the process 200 can include receiving a query requesting relationship data corresponding to a first entity. The relationship identification system 102 can receive the query requesting relationship data corresponding to the first entity. The relationship identification system 102 can receive the query via the computing device 104. For example, the query can be received as an input to a user interface. The query can request relationship data for one or more entities. In some embodiments, the query can include text (e.g., question, instructions) indicating a request for specific relationship data. As a non-limiting example, the query can include a request to determine when a relationship between two or more entities began. As another non-limiting example, the query can include a request to determine if the relationship is positive, negative, or neutral.

At step 206, the process 200 may include retrieving a plurality of media content artifacts. The relationship identification system 102 can retrieve the media content artifacts. For example, the relationship identification system 102 can by determining entities access a database of individuals or organizations (e.g., entities). The entities may include individuals or organizations relevant to the analysis being conducted (e.g., persons of interest and/or individuals associated with persons of interest). The database may include vast amounts of structured and/or unstructured data. For example, structured data may include organizational records, financial transactions, and/or personnel files, which may be systematically organized. Unstructured data may encompass a wide variety of formats and sources, such as publications, digital media articles, social media communications, blog posts, and/or emails. Moreover, the database may store electronic communications, multimedia files (e.g., images and videos), and/or online interactions that provide deeper insights into the behaviors and networks of entities. This robust integration of diverse data types may enhance the capability of the process 200 to perform nuanced analyses, leveraging rich datasets to map complex relationships effectively.

According to some aspects, the process 200 may classify certain articles as “adverse articles” based on their content, e.g., concerning one or more identified entities. For example, media can be classified as negative, positive, or neutral with respect to a specific entity or relationship between entities. As another example, the media as a whole can be classified as negative (e.g., indicating that the media is “adverse”), positive (e.g., indicating that the media is favorable), or neutral. This classification may be achieved through use of sentiment analysis machine learning models that assess the tone and context of mentions within the articles. For example, articles that include mentions of entities in contexts related to criminal activities, financial misconduct, or other negative connotations may be deemed as adverse. Moreover, the machine learning models may analyze textual data to determine the sentiment expressed, categorizing articles as adverse when they contain negative implications that could impact compliance assessments and risk management processes. In some aspects, the processed data may include adverse articles, or, in some other aspects, the processed data may consist of only articles that have been determined to be adverse. For example, the process 200 may identify and extract references to known terrorists or individuals involved in money laundering from online adverse articles, flagging these entities for further scrutiny and/or profiling.

The process 200 can include identifying adverse indicators in the media. The adverse indicators can include any word or phrases included in the media that indicate a negative sentiment or a positive sentiment. For example, an adverse indicator can include fraud, which can indicate a negative sentiment with respect to an entity committing fraud. As another example, process 200 can include identifying a context for each adverse indicator. The context can represent if the adverse indicator is related to or associated with an entity or a relationship between entities. Based on the adverse indicators, the process 200 can include identifying a sentiment based on the adverse indicators. The adverse indicators and the sentiment associated with each can be aggregated. A machine learning algorithm can be applied to the aggregate (e.g., the combined adverse indicators and sentiment) to predict an adverse classification (e.g., negative, positive, neutral) and a confidence score, indicating the accuracy of the adverse classification. For example, the adverse indicators and the sentiment can be aggregated into a data object and provided as an input to a machine learning algorithm. Process 200 can include ranking the media based on the adverse classification. As another example, process 200 can include storing media in the data store and tagging the media based on the identified entities, relationships, sentiments, adverse indicators, and adverse classification. The media can be filtered based on the tags.

One or more machine learning algorithms may predict and prioritize data relevance (e.g., based on one or more query parameters provided by a user). According to some aspects, the process 200 may prioritize information that has previously led to significant insights, thereby enhancing the efficiency of the search process. For example, if the query is related to financial transactions, the process 200 may automatically prioritize data involving past financial dealings and relationships within financial sectors. The predictive fetching may increase speeds and may enhance the relevance of the retrieved data. As another example, data can be prioritized based on inputs or instructions in the query.

According to some aspects, the process 200 may employ data transformation to standardize and integrate the data into a coherent format. For example, disparate data structures and terminologies may be aligned to ensure consistency across the database. This normalization may allow for accurate application of NLP and text link analysis in later steps of the process 200, as it ensures that all data used in analysis maintains integrity and uniformity.

Determining the entities may include using NLP to parse textual data to identify and classify different types of entities (e.g., individuals, organizations, locations, and/or dates). Entity recognition may be applied to scan text for patterns that match predefined entity models. For example, named entity recognition (NER) may be used to automatically detect names of people or companies within unstructured text. Once the entities (e.g., persons of interest or individuals associated with persons of interest) are identified, they may be tagged and categorized according to their roles or relationships, preparing the dataset for further relational analysis and linkage.

According to some aspects, the process 200 may create or update profiles for each entity. The profiles may be comprehensive, containing a variety of data pertinent to the entity, including basic identification details (e.g., names, titles, addresses, phone numbers, etc.) and/or relational data that outlines connections with other entities. New findings may be integrated into the profiles and/or existing information may be dynamically updated. Thereby each profile may remain current and reflective of the latest data, facilitating more accurate assessments of relationships and associated risks. Moreover, the profiles may maintain a detailed understanding of each entity’s network and interactions, which may be critical for compliance monitoring and risk management in environments governed by stringent regulatory requirements.

According to some aspects, the process 200 may cross-verify the automated extraction results with those obtained from secondary analysis methods or different computational models. For example, entities identified by a primary NLP model (e.g., Modeler) may be cross-checked using a secondary NLP model (e.g., Rosette) to confirm the accuracy of entity extractions. Discrepancies between the machine learning models may be identified to correct errors proactively, ensuring that only verified and accurate data is used in the profiling and monitoring processes.

At step 209, the process 200 can include identifying a reference to the first entity in the plurality of media content artifacts. The relationship identification system 102 can identify the references to the first entity in the media content artifacts. Identifying the reference can include determining that a media content artifact mentions or discusses the entities identified in the query. For example, the relationship identification system 102 can identify the references by scanning media articles (e.g., adverse articles) to extract references to each of the entities, one or more contextual links between the entities. The process 200 may parse through the media articles to identify references to the entities identified at step 210. NLP may be used to comb through structured and/or unstructured data across various media formats (e.g., online news articles, press releases, blog entries, and/or other relevant publications). The process 200 may meticulously extract any mentions of the identified entities, such as any adverse mentions of the identified entities. The comprehensive search may allow the process 200 to gather all necessary data that pertains to each entity. As an example, the relationship identification system 102 can identify one or more references to one or more entities.

According to some aspects, the process 200 may use text parsing to segment and analyze the content of each article. The process 200 may identify the occurrence of entity names using entity recognition sub-modules within the broader NLP framework. The text of the articles may be broken down into manageable pieces (e.g., phrases, sentences, or paragraphs) to contextually identify where and how each entity is mentioned. Moreover, the process 200 may recognize variations and synonyms of entity names to ensure thoroughness in capturing all references. For example, if an entity is a well-known public figure or organization, the process 200 may account for common abbreviations or alternate names used in different articles.

According to some aspects, the process 200 may tag the references with metadata that captures their occurrence within the text. The metadata may include the position of the reference within the article, the article source, publication date, and/or other contextual information. By meticulously cataloging where and how each entity is mentioned across a diverse set of media outputs, the process 200 may be prepared for deeper analytical processes associated with exploring the nature and dynamics of the mentions in relation to one another.

At step 212, the process 200 can include determining that at least one media content artifact identifies a second entity. The relationship identification system 102 can determine that at least one media content artifact from the plurality of media content artifacts identifies a second entity. For example, the relationship identification system 102 can determine that a media content artifact mentions or discusses the entities identified in the query. As another example, the relationship identification system 102 can identify a second entity discussed with reference to the first entity in one or more media content artifacts even if the second entity was not mentioned in the query. For example, the relationship identification system 102 can use any of the NLP techniques or other entity identification and extraction techniques described with reference to step 209 to determine that media content artifacts identify a second entity.

At step 215, the process 200 can include identifying a relationship between the first entity and the second entity. The relationship identification system 102 can identify a relationship between the first entity and the second entity. For example, the relationship identification system 102 may determine, by applying NLP and text link analysis to the references, a relationship between an entity of the plurality of entities and other entities of the plurality of entities. Step 215 utilizes advanced NLP and text link analysis techniques to interpret the data extracted during Steps 209 and 212, aiming to determine relationships between the identified entities. This includes analyzing the semantics of text to understand the relationships’ nature, such as partnership, competition, or customer relations. The system might identify, for example, that two entities frequently mentioned together in trade discussions or project collaborations likely have a business partnership or joint venture.

According to some aspects, the process 200 may use advanced NLP to analyze the media articles for references to the entities identified in the query and entities identified in the media content at steps 209 and 212. The NLP may include deep content analysis, extracting not only mentions of entities but also understanding the context in which the entities are discussed. The tone and intent of the mentions of the entities may be determined, which may range from positive to negative sentiments, or neutral descriptions, providing an understanding of the nature of the entity’s portrayal in public domains as well as the nature of the individual’s connections to the other entities. Moreover, the semantics of text may be analyzed to understand the relationships’ nature, such as partnership, competition, or customer relations. For example, the process 200 may identify that two entities frequently mentioned together in trade discussions or project collaborations likely have a business partnership or joint venture.

According to some aspects, the process 200 may include using text link analysis to detect and establish relationship between the entities based on their co-occurrences within the same articles or across multiple documents. Moreover, the process 200 may map the frequency and nature of the connections, categorizing the strength and type of relationships. For example, entities that frequently appear together in contexts related to specific events or projects may be linked with a ‘collaborative’ tag, whereas entities mentioned together in investigative reports may be linked with a ‘controversial’ tag. The links may be dynamically updated, and the contextual relationships may be refined as more data becomes available, ensuring that the connections reflect the most current information.

According to some aspects, the process 200 may update the profiles of the determined entities with the relationship data. Contextual links and/or relationship insights extracted from the various data sources may be incorporated into the entity profiles. For example, each profile may be augmented with the most current and relevant relationship information, reflecting the latest interactions and affiliations.

At step 218, the process 200 can include determining a sentiment associated with the relationship by applying a machine learning model to the reference. The relationship identification system 102 can determine a sentiment by applying a machine learning model to the reference, the entities, and any of the media content artifacts. By analyzing the emotional tone surrounding mentions of entities, the process 200 may identify underlying attitudes that may influence the perception of the relationships. Adjectives and verbs associated with entities may be parsed using a sentiment lexicon tailored to the specific domain of the entities involved. For example, the use of terms like “acclaimed” or “criticized” in close proximity to an entity’s name may provide insights into the public or industry sentiment towards that entity. This analysis may be used to construct a nuanced understanding of the entity’s reputation and relationships within the sector, aiding in the construction of a comprehensive relational map that is informed by both factual links and perceptual nuances.

Determining the sentiment can include evaluating the emotional tone of the text surrounding entity interactions to better understand the nature of the relationship and classify the relationship (e.g., based on whether the sentiment is positive, negative, or neutral). For example, if two entities are mentioned together with positive terms like “successful partnership,” it suggests a favorable relationship, which is different from a context filled with terms like “contentious litigation,” which could indicate a negative relationship. In the first example, the sentiment analysis module could classify the relationship as positive, and in the second example, the sentiment analysis module could classify the relationship as negative

At step 221, the process 200 can include generating a visual representation based on the relationship and the sentiment. The relationship identification system 102 can generate the visual representation based on the relationship and sentiment. The visual representation can include a relationship graph or chart that can be displayed on a user interface. Generating the visual representation may include transmitting, in response to a query comprising the entity of the plurality of entities, an indication of the relationship between the entity of the plurality of entities and the other entities of the plurality of entities. The process 200 may synthesize the information gathered and processed in earlier steps into actionable insights that are relevant to the query. For example, the query may specify one or more entities of interest, and the process 200 may provide a comprehensive indication of the relationships between the specified entity and other entities within the database. Moreover, the process 200 may access relational data prepared and stored in previous steps (e.g., one or more stored profiles), ensuring that the response is both accurate and reflective of the latest available information. For example, if a query asks for the relationship details of a specific person of interest within the context of industry partnerships, the process 200 may use optimized search algorithms to pull together all profiles where the person of interest is mentioned in relation to other entities in similar contexts. Moreover, the process 200 may extract and summarize details of joint ventures, co-sponsored events, and/or shared market spaces as documented in the media articles processed in earlier steps.

The process 200 may format the extracted relationship data into a user-friendly format before transmission. For example, the process 200 may create one or more visual graphs that depict the relationships dynamically, textual summaries that describe the nature and context of the relationships, and/or tabulated data that can be easily navigated. The choice of format may be tailored based on the user’s preferences or the specific requirements of the query interface being used. Thereby the process 200 may ensure that the information is transmitted efficiently and is presented in a way that can be immediately utilized by the user to make informed decisions or further analyses.

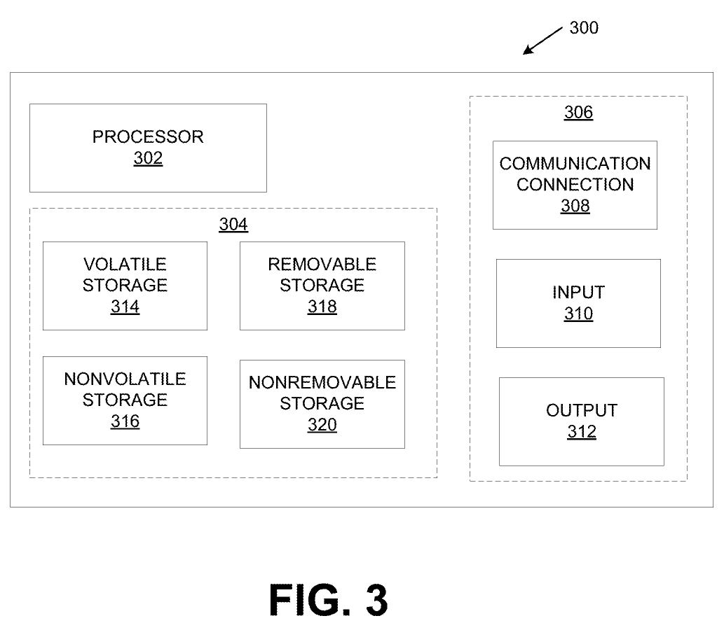

FIG. 3 is a block diagram of a computing device 300 that may be connected to or comprise a component of the relationship identification system 102. For example, the computing device 300 can include the computing device 104, the database 110, and/or the server 108. For example, the computing device 300 can perform any of the functionality described herein, including but not limited to process 200. Computing device 300 may comprise hardware or a combination of hardware and software. The functionality to facilitate relationship extraction may reside in one or a combination of computing devices 300. Computing device 300 depicted in FIG. 3 may represent or perform functionality of an appropriate computing device 300, or a combination of computing devices 300, such as, for example, a component or various components of a relationship extraction system, a computing device, a processor, a server, a gateway, a database, a firewall, a router, a switch, a modem, an encryption tool, a virtual private network (VPN), or the like, or any appropriate combination thereof. It is emphasized that the block diagram depicted in FIG. 3 is an example and is not intended to imply a limitation to a specific example or configuration. Thus, computing device 300 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Embodiments of the computing device 300 may comprise a processor 302 and a memory 304 coupled to processor 302. The memory 304 may contain executable instructions that, when executed by the processor 302, may cause the processor 302 to effectuate operations associated with relationship extraction. As evident from the description herein, the computing device 300 is not to be construed as software per se.

In addition to a processor 302 and memory 304, a computing device 300 may include an input/output system 306. The processor 302, memory 304, and input/output system 306 may be coupled together (coupling not shown in FIG. 3) to allow communications between them. Each portion of the computing device 300 may comprise circuitry for performing functions associated with each respective portion. Thus, each portion may comprise hardware, or a combination of hardware and software. Accordingly, each portion of a computing device 300 is not to be construed as software per se. An input/output system 306 may be capable of receiving or providing information from or to a communications device or other network entities configured for relationship extraction. For example, the input/output system 306 may include a wireless communication (e.g., 3G/4G/5G/GPS) card. The input/output system 306 may be capable of receiving or sending video information, audio information, control information, image information, data, or any combination thereof. Input/output system 306 may be capable of transferring information with the computing device 300. In various configurations, the input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, the input/output system 306 may comprise a Wi-Fi finder, a two-way GPS chipset or equivalent, or the like, or a combination thereof.

Embodiments of the input/output system 306 of a computing device 300 also may contain a communication connection 308 that allows the computing device 300 to communicate with other devices, network entities, or the like. The communication connection 308 may comprise communication media. Communication media may typically embody computer-readable instructions, data structures, program modules or other data in a modulated data signal such as a carrier wave or other transport mechanism and may include any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. The input/output system 306 also may include an input device 310 such as keyboard, mouse, pen, voice input device, or touch input device. The input/output system 306 may also include an output device 312, such as a display, speakers, or a printer.

Embodiments of the processor 302 may be capable of performing functions associated with relationship extraction, such as functions for automated processing and analysis of vast amounts of unstructured data to conduct precise, contextually relevant screenings for relationships with entities such as SOEs and NGOs, as described herein. For example, a processor 302 may be capable of, in conjunction with any other portion of the computing device 300, NLP and text link analysis in relationship extraction, as described herein.

Embodiments of a memory 304 of the computing device 300 may comprise a storage medium having a concrete, tangible, physical structure. As is known, a signal does not have a concrete, tangible, physical structure. The memory 304, as well as any computer-readable storage medium described herein, is not to be construed as a signal. The memory 304, as well as any computer-readable storage medium described herein, is not to be construed as a transient signal. The memory 304, as well as any computer-readable storage medium described herein, is not to be construed as a propagating signal. The memory 304, as well as any computer-readable storage medium described herein, is to be construed as an article of manufacture.

The memory 304 may store any information utilized in conjunction with relationship extraction. Depending upon the exact configuration or type of processor, a memory 304 may include a volatile storage 314 (such as some types of RAM), a nonvolatile storage 316 (such as ROM, flash memory), or a combination thereof. The memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by a computing device 300. The memory 304 may comprise executable instructions that, when executed by a processor 302, cause the processor 302 to effectuate operations associated with relationship extraction.

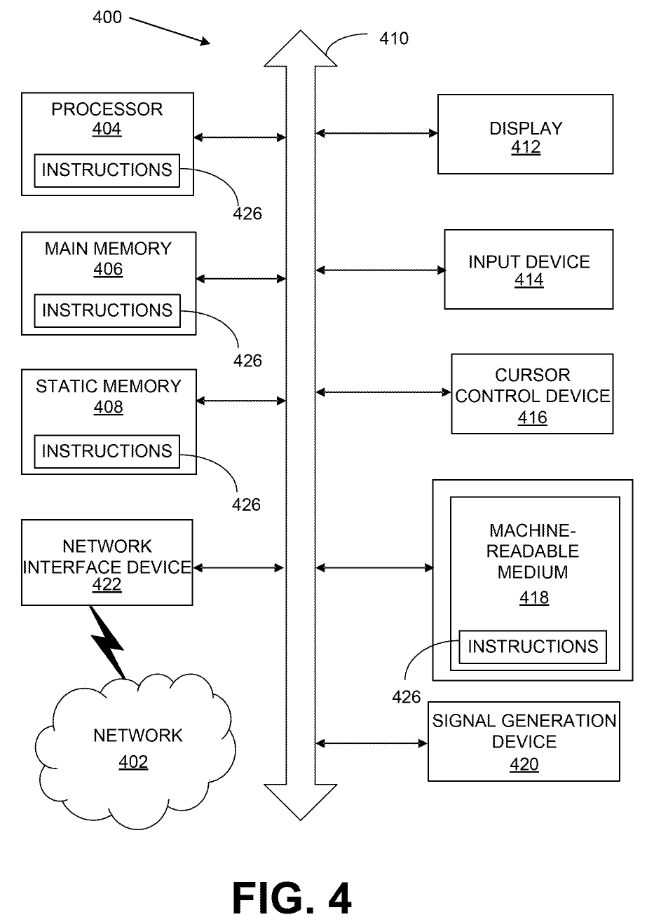

FIG. 4 depicts an example of a diagrammatic representation of a machine in the form of a computer system 400 within which a set of instructions, when executed, may cause the machine to perform any one or more of the methods described above. One or more instances of the machine can operate, for example, as computing device 300, processor 404, relationship identification system 102, computing devices 104, server 108, database 110, and other devices of FIGS. 1-3. For example, the computing device 300 can perform any of the functionality described herein, including but not limited to process 200. In some examples, the machine may be connected (e.g., using a network 402) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

A computer system 400 may include a processor (or controller) 404 (e.g., a central processing unit (CPU)), a graphics processing unit (GPU, or both), a main memory 406 and a static memory 408, which communicate with each other via a bus 410. The computer system 400 may further include a display unit 412 (e.g., a liquid crystal display (LCD), a flat panel, or a solid-state display). The computer system 400 may include an input device 414 (e.g., a keyboard), a cursor control device 416 (e.g., a mouse), a disk drive unit 418, a signal generation device 420 (e.g., a speaker or remote control) and a network interface device 422. In distributed environments, the examples described in the subject disclosure can be adapted to utilize multiple display units 412 controlled by two or more computer systems 400. In this configuration, presentations described by the subject disclosure may in part be shown in a first of display units 412, while the remaining portion is presented in a second of display units 412.

The disk drive unit 418 may include a tangible computer-readable storage medium on which is stored one or more sets of instructions (e.g., instructions 426) embodying any one or more of the methods or functions described herein, including those methods illustrated above. Instructions 426 may also reside, completely or at least partially, within the main memory 406, the static memory 408, or within the processor 404 during execution thereof by the computer system 400. The main memory 406 and the processor 404 also may constitute tangible computer-readable storage media.

While examples of a system for relationship extraction have been described in connection with various computing devices/processors, the underlying concepts may be applied to any computing device, processor, or system capable of facilitating a relationship extraction system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for relationship extraction. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a relationship extraction system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for relationship extraction as described herein. When implemented on a general-purpose processor, the program code combines with the processor to provide a unique device that operates to invoke the functionality of a relationship identification system.

While the disclosed systems have been described in connection with the various examples of the various figures, it is to be understood that other similar implementations may be used, or modifications and additions may be made to the described examples of a relationship identification system without deviating therefrom. For example, one skilled in the art will recognize that a relationship identification system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure – automatically processing and analyzing vast amounts of unstructured data to provide accurate, contextually relevant relationship extraction - as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. A system comprising:
one or more processors; and
a memory having instructions stored thereon that, when executed by the one or more processors, cause the system to:
receive a query requesting relationship data corresponding to at least one first entity;
retrieve a plurality of media content artifacts;
identify at least one reference to the at least one first entity in the plurality of media content artifacts based on applying a natural language processing technique to the plurality of media content artifacts, wherein at least one of the plurality of media content artifacts identifies at least one second entity;
identify a relationship between the at least one first entity and the at least one second entity based on the at least one reference;
determine a sentiment associated with the relationship based on applying a machine learning model to the at least one reference; and
generate a visual representation based on the relationship and the sentiment on a user interface displayed on the at least one computing device.

2. The system of claim 1, wherein the instructions, when executed by the one or more processors, further cause the system to:
identify a plurality of adverse indicators in a first media content artifact of the plurality of media content artifacts based on applying the natural language processing technique to the first media content artifact;
identify a second sentiment associated with each of the plurality of adverse indicators; and
generate a data object, wherein the data object aggregates each of the plurality of adverse indicators and the second sentiments.

3. The system of claim 2, wherein the instructions, when executed by the one or more processors, further cause the system to:
determine a classification of the first media content artifact based on applying a machine learning algorithm to the data object; and
determine a confidence score associated with the classification based on the data object.

4. The system of claim 3, wherein the classification comprises at least one of a positive classification, a negative classification, and a neutral classification.

5. The system of claim 3, wherein the instructions, when executed by the one or more processors, further cause the system to:
determine a context associated with each of the plurality of adverse indicators and the at least one first entity.

6. The system of claim 4, wherein the instructions, when executed by the one or more processors, further cause the system to:
rank each of the plurality of media content artifacts based on an adverse classification.

7. The system of claim 6, wherein the instructions, when executed by the one or more processors, further cause the system to:
store each of the plurality of media content artifacts in the memory; and
apply a metadata tag to each of the plurality of media content artifacts based on the classification.

8. The system of claim 6, wherein the instructions, when executed by the one or more processors, further cause the system to:
filter the plurality of media content artifacts into one or more categories based on the classification.

9. A method, comprising:
receiving, via one of one or more computing devices, a query requesting relationship data corresponding to at least one first entity;
retrieving, via one of the one or more computing devices, a plurality of media content artifacts;
identifying, via one of the one or more computing devices, at least one reference to the at least one first entity in the plurality of media content artifacts based on applying a natural language processing technique to the plurality of media content artifacts, wherein at least one of the plurality of media content artifacts identifies at least one second entity;
identifying, via one of the one or more computing devices, a relationship between the at least one first entity and the at least one second entity based on the at least one reference;
determining, via one of the one or more computing devices, a sentiment associated with the relationship based on applying a machine learning model to the at least one reference; and
generating, via one of the one or more computing devices, a visual representation based on the relationship and the sentiment on a user interface displayed on the at least one computing device.

10. The method of claim 9, further comprising:
extracting, via one of the one or more computing devices, data associated with the at least one first entity from the plurality of media content artifacts; and
updating, via one of the one or more computing devices, a profile associated with the at least one first entity to include the data.

11. The method of claim 9, further comprising:
extracting, via one of the one or more computing devices, data associated with the at least one second entity from the plurality of media content artifacts; and
generating, via one of the one or more computing devices, a profile associated with the at least one second entity, wherein the profile comprises the data.

12. The method of claim 9, further comprising:
predicting, via one of the one or more computing devices, an entity type associated with the at least one first entity based on the plurality of media content artifacts.

13. The method of claim 12, wherein the at least one first entity comprises at least one of an individual or an organization.

14. The method of claim 9, wherein the natural language processing technique comprises text link analysis.

15. The method of claim 9, further comprising:
determining, via one of the one or more computing devices, a relationship score based on the relationship and the sentiment.

16. A non-transitory computer-readable medium embodying a program that, when executed by at least one computing device, cause the at least one computing device to:
receive a query requesting relationship data corresponding to at least one first entity;
retrieve a plurality of media content artifacts;
identify at least one reference to the at least one first entity in the plurality of media content artifacts based on applying a natural language processing technique to the plurality of media content artifacts, wherein at least one of the plurality of media content artifacts identifies at least one second entity;
identify a relationship between the at least one first entity and the at least one second entity based on the at least one reference;
determine a sentiment associated with the relationship based on applying a machine learning model to the at least one reference; and
generate a visual representation based on the relationship and the sentiment on a user interface displayed on the at least one computing device.

17. The non-transitory computer-readable medium of claim 16, wherein the program further causes the at least one computing device to:
determine a change to the relationship between the at least one first entity and the at least one second entity based a second plurality of media content artifacts; and
generate an alert on the user interface in response to determining the change.

18. The non-transitory computer-readable medium of claim 16, wherein the program further causes the at least one computing device to:
identify the at least one second entity based on applying the natural language processing technique to the plurality of media content artifacts; and
validate the at least one second entity based on applying a second natural language processing technique to the plurality of media content artifacts.

19. The non-transitory computer-readable medium of claim 18, wherein the natural language processing technique comprises named entity recognition.

20. The non-transitory computer-readable medium of claim 18, wherein the natural language processing technique comprises tokenization.
